(19) United States
(12) Patent Application Publication
(10) Pub. No.: US 2012/0209444 A1
(43) Pub. Date: Aug. 16, 2012

(54) DEVICE AND METHOD FOR CONTROLLING ELECTRIC PRODUCT

(76) Inventors: Daegeun Seo, Seoul (KR); Munseok Seo, Seoul (KR); Jinseong Hwang, Seoul (KR)

(21) Appl. No.: 13/504,031

(22) PCT Filed: Oct. 26, 2010
(86) PCT No.: PCT/KR2010/007356

§ 371 Date: Apr. 25, 2012

(30) Foreign Application Priority Data
Oct. 26, 2009 (KR) 1020090101943
Oct. 26, 2009 (KR) 1020090101944

(51) Int. Cl. G06F 1/32

(52) U.S. Cl. 700/295

(57) ABSTRACT

Provided is a control device for controlling an electric product. The control device includes a power source unit, an input unit, an output unit, a communication unit, and a control unit. The power source unit supplies power to the electric product. The input unit is configured to input an operation mode related with a power saving driving of the electric product or input a command related with a driving method of the electric product. The output unit outputs information corresponding to the command input through the input unit or information related with driving of the electric product. The communication unit communicates information related with energy supplied to the electric product. The control unit controls an operation of the electric product based on a command related with the operation mode or a course of the driving. The operation mode includes a normal operation mode and a power saving operation mode.

### TECHNICAL FIELD

The present disclosure relates to a device and a method for controlling an electric product.

### BACKGROUND ART

Electric home appliances and office equipment include washing machines, cooking appliances, and refrigerators.

Since electric products consume electric energy, the amount of electricity consumption or electric rates may be a sensitive matter to users. As energy consumption increases, it is necessary to develop more energy sources and generate electric energy. However, electricity generation causes generation of a large amount of greenhouse gas and environmental problems such as global warming.

To reduce emission of greenhouse gas, particularly, carbon dioxide, alternative energy sources have been developed such as wind power, solar light, solar heat, geothermal power, tidal power, and water power as well as nuclear power and fuel cells. Along with this, a smart grid has been proposed as the next generation power grid to improve energy efficiency by realizing two-way and real-time information exchange between power providers and consumers in a way of applying information technology (IT) to the existing power grid.

In a device and a method for controlling an electric product in the related art, it is difficult to provide power/energy saving information to a user when the electric product operates, thus, the efficiency in using the electric product may be degraded.

In addition, in a device and a method for controlling an electric product in the related art, since a greenhouse emission amount from an energy source is not considered, it is difficult to address environmental pollution such as global warming.

### DISCLOSURE OF INVENTION

### Technical Problem

Embodiments provide a control device for controlling an electric product, which provides power information when the electric product operates, and a method of controlling the electric product.

Embodiments also provide a control device for controlling an electric product, which provides an estimated end time or an estimated electricity charge according to an operation mode of the electric product, and a method of controlling the electric product.

Embodiments also provide a control device for controlling an electric product, which provides, periodically or at a point when a time period is changed, time information and information about an electricity charge time period related with an electricity charge to perform a power saving operation, and a method of controlling the electric product.

Embodiments also provide a control device for controlling an electric product, which provides power information including electricity charge information through a wire/wireless communication unit to save power, and a method of controlling the electric product.

Embodiments also provide a control device for an electric product, which provides a power consumption amount according to an operation of an electric product, an estimated greenhouse gas emission amount according to an energy source, or an electricity charge to a user such that the user considers the saving of power with respect to power consumption, greenhouse gas, or an electricity charge, and a method of controlling the electric product.

### Solution to Problem

In one embodiment, a control device for controlling an electric product includes: a power source unit configured to supply power to the electric product; an input unit configured to input an operation mode related with a power saving driving of the electric product or input a command related with a driving method of the electric product; an output unit configured to output information corresponding to the command input through the input unit or information related with driving of the electric product; a communication unit configured to communicate information related with energy supplied to the electric product; and a control unit configured to control an operation of the electric product based on a command related with the operation mode or a course of the driving, wherein the operation mode includes a normal operation mode and a power saving operation mode, and estimated energy information corresponding to the normal operation mode and the power saving operation mode is displayed on the output unit, in conjunction with the driving of the electric product.

In another embodiment, a control device for controlling an electric product includes: a communication unit configured to receive energy information supplied to the electric product; an input unit configured to input an operation mode related with power saving driving of the electric product or input a command related with a driving method of the electric product; an output unit configured to output information corresponding to the command input through the input unit or output information related with driving of the electric product; and a control unit configured to control an operation of the electric product, based on a command related with the operation mode or a course of the driving, wherein estimated energy information related with the operation of the electric product is displayed on the output unit, based on the operation mode, and the estimated energy information includes time information.

In further another embodiment, a method of controlling an electric product includes: receiving energy information supplied to an electric product; inputting information about a driving method of the electric product; displaying estimated energy information according to one or more operation modes, based on the energy information; setting one of the operation modes; and driving the electric product in the set operation mode.

The details of one or more embodiments are set forth in the accompanying drawings and the description below. Other features will be apparent from the description and drawings, and from the claims.

### Advantageous Effects of Invention

In the control device and the method for controlling the electric product according to the embodiment, power information is provided to a user when the electric product operates, so that the user can effectively perform a power saving operation.

In addition, electricity charge time period information and time information related with an electricity charge are provided periodically or at a point when a time period is changed, so that a user can reasonably select a process and perform an effective power saving operation.

In addition, power consumption according to an operation of an electric product, a greenhouse gas estimated emission amount according to an energy source, or an electricity charge is provided to a user such that the user considers the saving of power with respect to power consumption, greenhouse gas, or an electricity charge.

According to the embodiments, power consumptions can be dispersed and peak power can be reduced, thereby constructing the smart grid and saving energy.

In addition, an estimated end time or an estimated electricity charge according to an operation mode of the electric product is provided, thereby reasonably adjusting an operation time and saving power.

In addition, power information including electricity charge information is provided through a wire/wireless communication unit to save power.

### BRIEF DESCRIPTION OF DRAWINGS

FIG. 1 is a perspective view illustrating an electric product according to a first embodiment.

FIG. 2 is a cross-sectional view illustrating the electric product of FIG. 1.

FIG. 3 is a block diagram illustrating a control device of the electric product according to the first embodiment.

FIG. 4 is a schematic view illustrating a screen of an output unit of FIG. 3.

FIG. 5 is a flowchart illustrating a method of controlling an electric product according to according to the first embodiment.

FIGS. 6A to 7F are views illustrating operations of the electric product according to operation modes according to the first embodiment.

FIGS. 8 and 9 are screens of the output unit describing operations of the electric product according to operation modes according to the first embodiment.

FIG. 10 is a schematic view illustrating a screen of an output unit constituting a control device of an electric product according to the second embodiment.

FIG. 11 is a flowchart illustrating a method of controlling the electric product according to the second embodiment.

FIG. 12 is a flowchart illustrating another example of the method of controlling the electric product according to the second embodiment.

### MODE FOR THE INVENTION

Reference will now be made in detail to the embodiments of the present disclosure, examples of which are illustrated in the accompanying drawings.

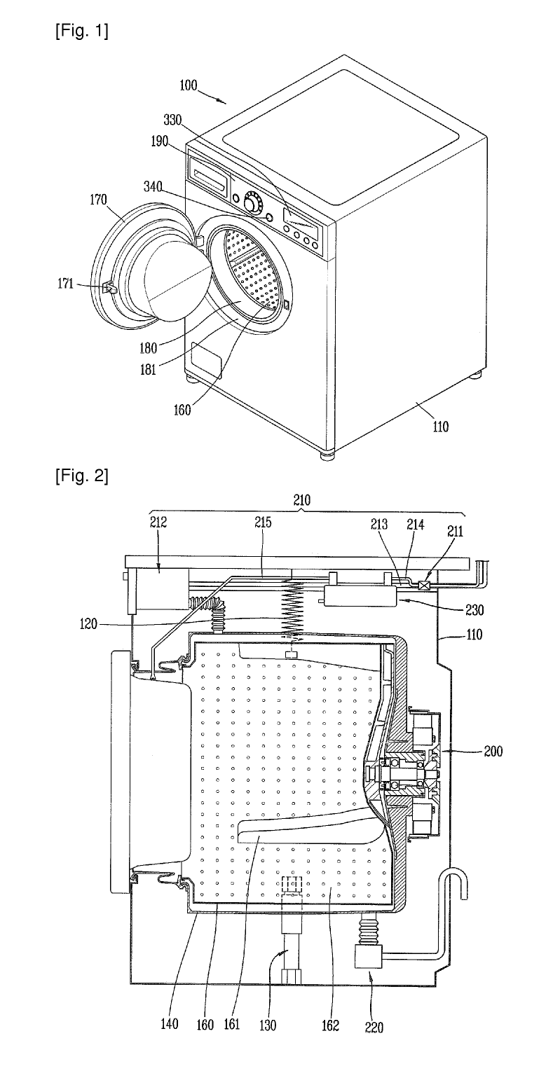

FIG. 1 is a perspective view illustrating a washing machine as an electric product according to a first embodiment. FIG. 2 is a cross-sectional view illustrating the electric product of FIG. 1.

Referring to FIGS. 1 and 2, a drum washing machine 100 according to the current embodiment includes a cabinet 110 provided with an insertion hole 181 allowing access to a laundry, a door 170 for opening and closing the insertion hole 181, a tub 140 installed within the cabinet 110 to absorb shock and receive washing water, a water supply member 104 including water supply passages 213 and 214 for supplying washing water to the tub 140, a discharge device 220 discharging washing water contaminated in the tub 140, a drum 160 rotatably disposed in the tub 140 to receive a laundry, a motor 200 installed on the tub 140 to rotate the drum 160, and a door switch 171 for locking or unlocking the door 170.

A gasket 180 for sealing the space between the insertion hole 181 and the tub 140 is disposed around the insertion hole 181.

The gasket 180 has an approximately ring or annulet shape with a predetermined height, and the middle part thereof is folded for overlapping. That is, the gasket 180 having a shape to surround the upper and lower parts of the door 170 is folded for overlapping.

A control panel 190 is disposed on the upper portion of the front part of the drum washing machine 100. The control panel 190 includes an output unit 330 displaying various types of information including usage information of the drum washing machine 100, and an input unit 340 receiving information input by a user or a manager, adjustment devices, input devices, and display devices.

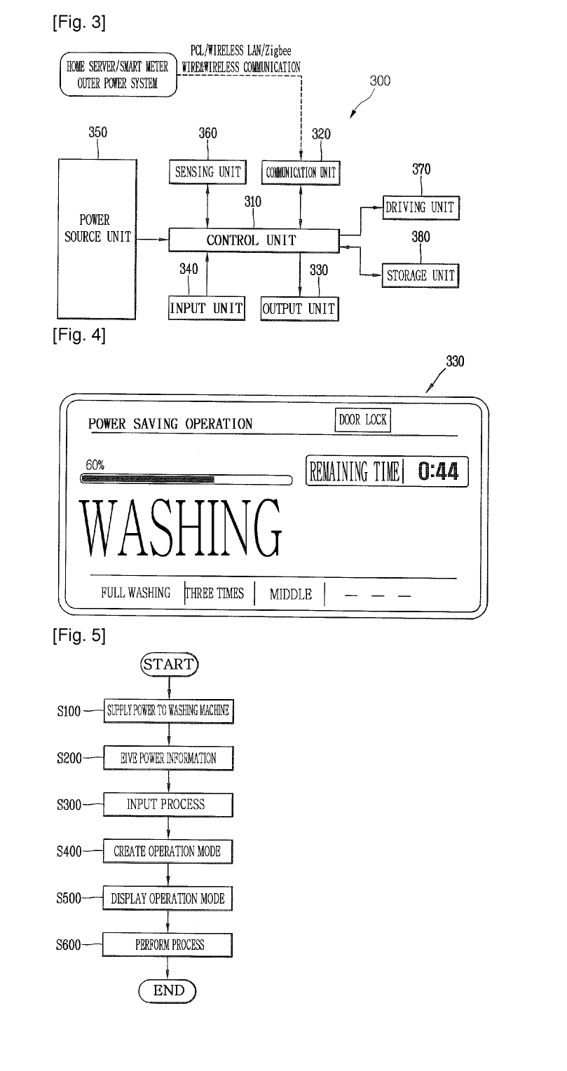

A control device 300 (refer to FIG. 3) is disposed within the control panel 190 to control the drum washing machine 100 including the output unit 330 according to signals input from the input devices or an internal control algorithm. The control device 300 may be disposed at another position of the drum washing machine 100.

In more detail, referring to FIG. 2, the drum washing machine 100 includes the cabinet 110 forming its appearance, the tub 140 suspended through a spring 120 within the cabinet 110 and supported by a damper assembly 130, the drum 160 rotatably installed within the tub 140 to receive washing water and a laundry, lifts 161 protruding from an inner wall of the drum 160 and spaced a constant distance from one another to raise up a laundry and drop it according to the rotation of the drum 160, the motor 200 connected to the drum 160 behind the tub 140 to rotate the drum 160, and an evaporation device 230 disposed above the tub 140 to heat washing water with high temperature and high pressure vapor and supply the water into the tub 140 and the drum 160.

As illustrated in FIG. 2, a discharge side of the evaporation device 230 may communicate with the inner space of the tub 140.

The drum washing machine 100 further includes a water supply member 210 disposed above the tub 140 to supply washing water into the tub 140 and the drum 160, and a water discharge device 220 disposed below the tub 140 to discharge washing water from the tub 140 and the drum 160. The evaporation device 230 is connected to the water supply member 210.

In detail, the water supply member 210 includes a water supply valve assembly 211 installed on the rear surface of the cabinet 110 to adjust the supplying of water, a detergent box assembly 212 connected between the water supply valve assembly 211 and the tub 140 and storing a detergent, first and second water supply passages 213 and 214 branched from the water supply valve assembly 211 and connected respectively to the detergent box assembly 212 and the evaporation device 230, and a vapor passage 215 having an end connected to the evaporation device 230 and another end disposed in the tub 140 and the drum 160 to supply vapor into the tub 140 and the drum 160.

The inner wall of the drum 160 is provided with a plurality of dehydration holes 162 such that washing water freely flows to the drum 160 and the tub 140 and washing water is removed from a laundry by centrifugal force. The water supply valve assembly 211 includes a water supply valve (not shown) to supply washing water according to an operation of the water supply valve, and the water discharge device 220 includes a water discharge pump (not shown) to discharge washing water according to an operation of the water discharge pump.

FIG. 3 is a block diagram illustrating a control device of the electric product according to the first embodiment. FIG. 4 is a schematic view illustrating a screen of an output unit of FIG. 3.

Referring to FIG. 3, a control device 300 of a washing machine according to the current embodiment includes a power source unit 350 connected to an outer power source to supply power into the washing machine; a sensing unit 360 for sensing state information of the washing machine, including a laundry amount and a water supply temperature; an input unit 340 for setting an operation mode of the washing machine and inputting a process (including a course or a predetermined driving method); an output unit 330 displaying an operation mode and a process which are input through the input unit 340 or currently operated; a communication unit 320 connected to an outer device through a wire/wireless communication method and receiving energy information, for example, power information (energy information) including electricity charge time period information or time information; and a control unit 310 performing the process based on the operation mode and the power information. The operation mode is a normal operation mode or at least one power saving operation mode.

In the current embodiment, the process is exemplified as a driving method. However, even when an electric product is a refrigerator, a drying machine, an air conditioner, a cooking appliance, a cleaner, a water purifier, or a massage device, a driving method corresponding to the characteristics of the electric product may be set.

The electricity charge time period information of the power information includes information about a normal time period and a peak time period. A higher electricity price is charged within the peak time period than within the normal time period. The normal time period is separated from the peak time period by a predetermined set reference. The electricity charge time period information includes start times and end times of the normal time period and the peak time period.

A time period when a total power usage amount increases and a remaining power to be supplied to each residential customer decreases to a predetermined value or less is set as a peak time period by a power provider, based on a statistic material or through a real time observation. Thus, the power provider may adjust the using of power by charging a high electricity price in the peak time period. The normal time period is a time period except for the peak time period. Information about the peak time period may be stored in advance in the outer device, that is, at least one of an outer power system and an in-house power related device such as a home server and a smart meter. The power provider can provide the electricity charge time period information in real time. The time information includes present time information that is given to each washing machine to accurately calculate electricity charges.

The communication unit 320 is connected to the outer device through a wire/wireless communication method to receive the power information. The wire/wireless communication method may any communication method such as a power line communication, wireless LAN, Internet, Zigbee, and a serial communication for data transmission.

One of the normal operation mode and at least one power saving operation modes may be set through the input unit 340. The normal operation mode is a driving method in a time intended by a user without considering the information about energy (power information). On the contrary, the power saving operation mode is a driving method in a time that is at least partially out of the peak time period, considering the information about energy (power information).

When received power information is the normal time period, the control unit 310 performs the process in the normal operation mode. When received power information is the peak time period, the control unit 310 performs the process according to the set operation mode. That is, if the washing machine is set to the normal operation mode, even when the peak time period as power information is received, the control unit 310 of the washing machine performs the process in the normal operation mode. On the contrary, if the washing machine is set to the power saving operation mode, when the peak time period as power information is received, the washing machine performs the process in the power saving operation mode. The operation modes may be automatically switched according to an arbitrary condition.

The power source unit 350 receives the outer power, that is, commercial alternating current (AC) power to output a direct current (DC) voltage for driving circuits and units constituting the washing machine and the control device 300. A switched-mode power supply (SMPS) is used as the power source unit 350. As a matter of course, other power conversion devices may be used than the SMPS. The SMPS rectifies and smoothes an AC voltage of outer power to form a DC voltage, and uses a transforming unit such as a high frequency transformer and a regulator to covert the DC voltage to driving voltages for the washing machine and the control device 300.

The sensing unit 360 senses a laundry amount and a water supply temperature and transmits information of the sensed amount and temperature to the control unit 310. The control unit 310 can calculate estimated power consumption and an estimated electricity charge of the washing machine, based on one of the set process and the sensed laundry amount and water supply temperature. The sensing unit 360 senses various types of state information for performing a normal process of the washing machine, and may include a sensor sensing a water level, a sensor sensing a rinsing degree, a sensor sensing a laundry leaning amount, and a sensor sensing a vibration amount of the washing machine. The sensing unit 360 transmits information sensed by the sensors to the control unit 310.

As illustrated in FIG. 4, the output unit 330 displays an operation mode input through the input unit 340 and a process to be performed by the washing machine, or an operation mode and a process that are currently operated.

The driving unit 370 receives a driving signal from the control unit 310 to drive loads for performing separate processes. The loads include the motor 200 rotating a washing drum, a heater for heating water supplied for boiling a laundry, a heater for providing steam, a heater for heating air to dry a laundry, and a fan and a fan motor for generating an air flow during the drying of a laundry.

Based on the power information, the control unit 310 calculates an estimated electricity charge and an estimated end time according to the operation modes. The output unit 330 displays at least one of the power information, the operation modes, the estimated electricity charge, and the estimated end time.

The power information includes the type of the outer power source and a greenhouse gas index according to the outer power source. Based on the power information, the control unit 310 calculates an estimated electricity charge and a greenhouse gas emission amount. The output unit 330 displays at least one of the type of the outer power source, the greenhouse gas index, the power consumption, the estimated electricity charge, and the estimated greenhouse gas emission amount. The control unit 310 may calculate an estimated greenhouse gas emission amount of an outer power source supplied to the washing machine, based on the calculated estimated power consumption. For example, a carbon dioxide index depending on the power source may be multiplied by the calculated estimated power consumption to obtain an estimated emission amount of carbon dioxide. Here, the energy source may include fossil fuels such as oil and gas; alternative energy sources such as solar light, solar heat, wind power, tidal power, water power, and geothermal power; nuclear power; and fuel cells. The greenhouse gas index depending on each power source, for example, the carbon dioxide index may be set through experiments.

That is, the control unit 310 calculates a greenhouse gas emission amount of the outer power source. The output unit 330 displays at least one of the type of the outer power source, the greenhouse gas index, and the greenhouse gas emission amount. The communication unit 320 may transmit information such as a power demand amount of the washing machine, an electricity charge, and a greenhouse gas emission amount to the outside through the wire/wireless communication method.

The control device may further include a storage unit (not shown) that stores at least one of a process to be performed by the washing machine and programmed in advance, a command input through the input unit 340, state information sensed through the sensing unit 360, each information displayed through the output unit 330, power information received through the communication unit 320, and data calculated through the control unit 310.

FIG. 5 is a flowchart illustrating a method of controlling an electric product according to according to the first embodiment.

Referring to FIG. 5, in a method of controlling the washing machine, power information including electricity charge time period information and time information is received in operation S200, a process (course) to be performed by the washing machine is input in operation S300, an estimated electricity charge and an estimated end time according to one or more operation modes is calculated based on the power information in operation S400, and the process is performed in one of the operation modes in operation S600. In addition, in the method of controlling the washing machine, one of the operation modes is set (not shown). The operation mode is a normal operation mode or at least one power saving operation mode. In the method of controlling the washing machine, at least one of the power information, the operation mode, the estimated electricity charge, and the estimated end time is displayed in operation S500.

In the method of controlling the washing machine, the power information may include the type of an outer power source that supplies power to the washing machine and a greenhouse gas index according to the outer power source. In addition, in the method of controlling the washing machine, an estimated greenhouse gas emission amount of the outer power source may be calculated (not shown), and at least one of the type of the outer power source, the greenhouse gas index, and the estimated greenhouse gas emission amount may be output (not shown).

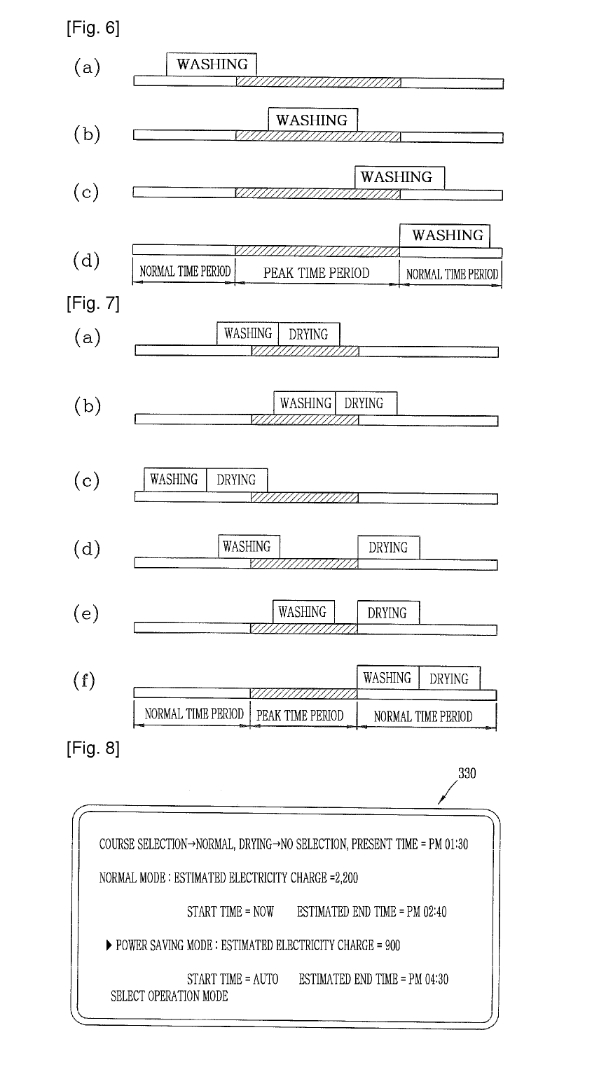

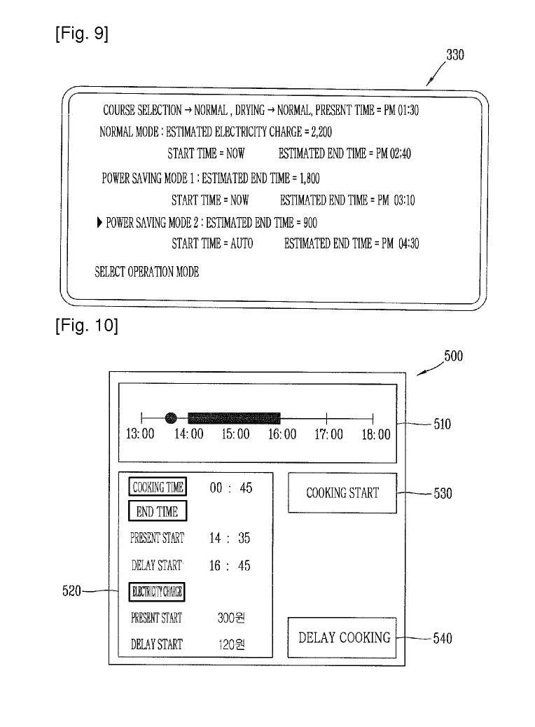

FIGS. 6A to 7F are views illustrating operations of the electric product according to operation modes according to the first embodiment. FIGS. 8 and 9 are screens of the output unit describing operations of the electric product according to operation modes according to the first embodiment.

Operations of a control device of the washing machine will now be described with reference to FIGS. 6A to 9 according to the first embodiment.

Referring to FIGS. 6A to 6D, only a washing process is performed without selecting a drying process. FIGS. 6A to 6C illustrate a start and an end of the washing process according to a normal operation mode, and FIG. 6D illustrates a start and an end of the washing process according to a power saving operation mode.

Only the washing process is input to the input unit 340, and the communication unit 320 receives power information such as a start and an end of a peak time period and a present time which are received through a wire/wireless communication method that may any communication method such as a power line communication, wireless LAN, Internet, Zigbee, and a serial communication from an outer power system or an inhouse power related device such as a home server and a smart meter. Based on the power information and the process, the control unit 310 calculates an estimated electricity charge and an estimated end time of the washing process according to the operation modes. As illustrated in FIG. 8, the output unit 330 displays the calculated estimated electricity charge and estimated end time to allow a user to set one of the displayed operation modes. When one of the displayed operation modes is set, the control unit 310 performs the washing process according to the set operation mode.

Referring to FIG. 8, information in the normal operation mode and the power saving operation mode, for example, a start time, an estimated end time, or an estimated electricity charge is displayed to be compared with one another on the output unit 330.

Referring to FIG. 8, the output unit 330 displays a present time, a currently input process, information that the start time is a present time (NOW) in the normal operation mode and the estimated end time is 2:40 pm and the estimated electricity charge is 2200 wons, and information that the start time is automatically selected (AUTO) in the power saving operation mode and the estimated end time is 4:30 pm and the estimated electricity charge is 900 wons.

As illustrated in FIG. 8, the output unit 330 may simultaneously display various types of related information in both the normal operation mode and the power saving operation mode, or the output unit 330 may sequentially display the various types of related information.

For example, an estimated end time or an estimated electricity charge in the normal operation mode is displayed first on the output unit 330, and then, a screen is changed to display to display an estimated end time or an estimated electricity charge in the power saving operation mode on the output unit 330.

Another embodiment will now be described.

Before information for a mode selection is displayed on the output unit 330, the normal operation mode or the power saving operation mode may be selected.

When the normal operation mode is selected, a screen as illustrated in FIG. 8 may be output. That is, information for saving costs may be additionally provided to a user. The user may check estimated energy information about the normal operation mode and the power saving operation mode, and then, may select the power saving operation mode. As a matter of course, when the user selects again the normal operation mode, the electric product operates in the selected normal operation mode.

Referring to FIGS. 7A to 7F, a washing process with a drying process is performed. FIGS. 7A to 7C illustrate a start and an end of the washing and drying processes according to the normal operation mode. FIG. 7D illustrates starts and ends of the washing and drying processes according to a first power saving operation mode in which the washing process is performed regardless of a peak time period and only the drying process is performed out of the peak time period. FIG. 7F illustrates starts and ends of the washing and drying processes according to a second power saving operation mode in which the washing and drying processes are performed out of the peak time period.

Signals for the washing process and drying process are input to the input unit 340, the communication unit 320 receives information about a start and an end of the peak time period and power information such as a present time through a wire/wireless communication method from an outer device. Based on the power information and the process, the control unit 310 calculates an estimated electricity charge and estimated end times of the washing and drying processes according to the operation modes. As illustrated in FIG. 9, the output unit 330 displays the calculated estimated electricity charge and estimated end times to allow the user to set one of the displayed operation modes. When one of the displayed operation modes is set, the control unit 310 sequentially performs the washing and drying processes according to the set operation mode, or the control unit 310 performs the drying process when a predetermined time is elapsed after the washing process.

Referring to FIG. 9, the output unit 330 displays a present time, a currently input process, information that the start time is a present time (NOW) in the normal operation mode and the estimated end time is 2:40 pm and the estimated electricity charge is 2200 wons, information that the start time is the present time (NOW) in the first power saving operation mode and the estimated end time is 3:10 pm and the estimated electricity charge is 1800 wons, and information that the start time is automatically selected (AUTO) in the second power saving operation mode and the estimated end time is 4:30 pm and the estimated electricity charge is 900 wons, so that the user can select the operation modes. The automatically selected start time may be a time that is at least partially disposed out of the peak time period according to energy information.

Another embodiment will now be described.

If a process to be performed is a heat washing process, a control device for controlling the washing machine may generates a power saving operation mode in which a standby state is maintained until a peak time period is ended. If a process to be performed is a rinsing process, the control device may generate a power saving operation mode in which a standby state is maintained until the peak time period is ended, or may generate a power saving operation mode in which the rinsing process is performed regardless of the peak time period since the rinsing process requires low power consumption. If a process to be performed is a full dehydrating process including a drying process, the control device of the washing machine may generate a power saving operation mode in which a dehydrating process is performed and the drying process is not performed until the peak time period is ended, or a power saving operation mode in which both the dehydrating process and the drying process are not performed until the peak time period is ended. If a process to be performed is a drying process, the control device of the washing machine may generate a power saving operation mode in which a heater is stopped, and a motor is driven at a lowest speed and a lowest actual operation rate. In this case, when two or more heaters are provided, the heaters may be sequentially or simultaneously stopped.

In the control device of the washing machine and the method of controlling the washing machine according to the present disclosure, the power is applied to the washing machine, and power information including information about an electricity charge time period and time information is received from the outer device through the inner communication unit to provide the information to a user through the output unit. Therefore, the user can select a reasonable method for saving the power. Also, the power saving operation mode is performed within the peak time period to reasonably use energy. In addition, in the control device of the washing machine and the method of controlling the washing machine according to the present disclosure, the type of an outer power source and a greenhouse gas index depending on the outer power source may be received from the outer device, and the estimated electricity charge and the greenhouse gas emission amount are calculated based on the type of the outer power source and the greenhouse gas index. Thus, the user can save the power. That is, in the control device of the washing machine and the method of controlling the washing machine according to the present disclosure, a user may confirm the reality of power usage of an electric product and electricity usage in real time, and be guided to voluntary energy saving. Thus, the peak power may be reduced at the national level to contribute to a build of the next generation power grid such as the smart grid.

Hereinafter, a second embodiment will now be described. Here, different parts between the first and second embodiments will be described principally, and a description of the same parts thereof will be omitted. In the current embodiment, a cooking appliance will be exemplified as an electric product.

FIG. 10 is a schematic view illustrating a screen of an output unit constituting a control device of an electric product according to the second embodiment.

Referring to FIG. 10, the control device includes an output unit 500. The output unit 500 displays a time graph 510 according to a present time and power information received through the communication unit 320; and operation information 520 including a cooking time according to a cooking course, and an estimated end time and an estimated electricity charge calculated according to an operation mode based on the cooking course and the power information.

As illustrated in FIG. 10, the present time is 13:50 between 13:00 and 14:00, and a peak time period ranges from 14:00 to 16:00, and the rest is a normal time period. When the cooking starts without delay, the estimated end time (‘END TIME’ of FIG. 10) is 14:35. In a power saving operation mode that the cooking starts out of the peak time period, the estimated end time is 16:45. When the cooking starts without delay, the estimated electricity charge (‘ELECTRICITY CHARGE’ of FIG. 10) is 300 wons. When the cooking is delayed, the estimated electricity charge is 120 wons. As described above, when an operation mode is previously set, the cooking starts according to the set operation mode. However, as illustrated in FIG. 10, various types of information are displayed through the output unit 500, and then, an operation mode may be selected using a cooking button.

The output unit 500 and the input unit 340 may be coupled to form a single input/output unit. The input/output unit may include a touch pad or a touch screen. The input/output unit may include a cooking start button 530 for inputting a command that the cooking starts without delay, and a delay cooking button 540 for start the cooking in the power saving operation mode out of the peak time period. The cooking may be performed by pressing one of the cooking start button 530 and the delay cooking button 540.

The output unit 500 displays at least one of the type of the outer power source, the greenhouse gas index, and the greenhouse gas emission amount. The communication unit 320 may transmit information such as a power demand amount of the cooking appliance, an electricity charge, and a greenhouse gas emission amount to the outside through the wire/wireless communication method.

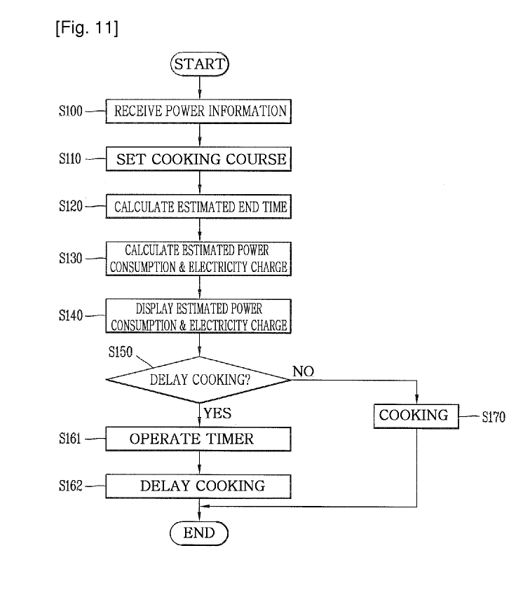

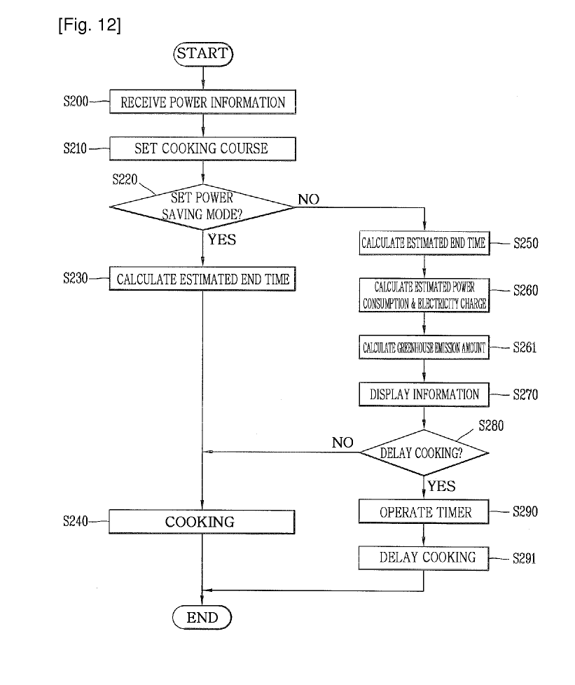

FIG. 11 is a flowchart illustrating a method of controlling the electric product according to the second embodiment. FIG. 12 is a flowchart illustrating another example of the method of controlling the electric product according to the second embodiment.

Referring to FIG. 11, in the method of controlling the electric product according to the second embodiment, power information including electricity charge information is received using a wire/wireless communication method from an outer device in operation S100, and a cooking course is set in operation S110, and an estimated end time or an estimated electricity charge is calculated based on the cooking course and the power information in operations S120 and S130. In addition, in the method of controlling the cooking appliance, the calculated estimated end time or estimated electricity charge is displayed in operation S140.

In addition, in the method of controlling the cooking appliance, an operation mode of the cooking appliance is set in operation S150, in which the operation mode is a normal operation mode or at least one power saving operation mode. In operations S120 and 130, the estimated end time or the estimated electricity charge is calculated according to the operation mode. In addition, in the method of controlling the cooking appliance, a cooking method is displayed according to the operation mode in operation S140. That is, in the method of controlling the cooking appliance, the cooking starts without delay according to the normal operation mode, the delay cooking starts out of the peak time period according to the power saving operation mode are separately displayed to be selected by a user on the screen. At this point, at least one of the calculated estimated end time, estimated power consumption, and estimated electricity charge is provided, so that power saving can be considered in using the cooking appliance.

When the normal operation mode or the power saving operation mode is selected, information related with the selected mode is displayed on the output unit 330, and the electric product can be operated according to the selected mode and the driving method (course).

Referring to FIG. 12, in the method of controlling the electric product according to the second embodiment, power information including electricity charge information is received using a wire/wireless communication method from an outer device in operation S200, and a cooking course is set in operation S210, and it is determined whether the power saving mode is set in operation S220, and cooking is performed from operation S230 and to the end according to a result of the determining. According to the result of the determining, if the power saving mode is set, the estimated end time is calculated based on the cooking course in operation S230, and the cooking starts in operation S240 according to the power saving mode that is stored in advance. To this end, cooking methods in the normal time period and the peak time period may be programmed in advance to perform the cooking. Although not shown, also when the normal operation mode is set, the cooking appliance can be controlled in the same manner.

According to the result of the determining, if the power saving mode is not set, estimated power consumption and an estimated electricity charge are calculated based on the cooking course and the power information according to all operation modes in operation S260. In addition, in the method of controlling the cooking appliance, the calculated estimated end time or estimated electricity charge is displayed in operation S270. In addition, in the method of controlling the cooking appliance, the cooking method is displayed according to the operation mode. That is, in the method of controlling the cooking appliance, the cooking starts without delay according to the normal operation mode, the delay cooking starts out of the peak time period according to the power saving operation mode are separately displayed to be selected by a user on the screen. At this point, at least one of the calculated estimated end time, estimated power consumption, and estimated electricity charge is provided, so that power saving can be considered in using the cooking appliance.

Referring to FIGS. 10 to 12, in the method of controlling the cooking appliance according to the second embodiment, the power information including the electricity charge information is received using the wire/wireless communication method from the outer device in operation S100/S200, and the cooking course is set in operation S110/S210, When the power saving operation mode is previously set, the estimated end time is calculated according to the set operation mode in operation S230, and the cooking start in operation S240. However, as illustrated in FIG. 10, various types of information are displayed, and then, the operation mode may be selected using the cooking button in operation S150/S280.

That is, the estimated end time is calculated based on the cooking course and the power information in operation S120/S250, or the estimated power consumption and the estimated electricity charge according to the estimated power consumption are calculated in operation S130/S260. Thereafter, the time graph 510 according to the power information and the present time; and the operation information 520 including the cooking time according to the cooking course, and the estimated end time and the estimated electricity charge calculated according to the operation mode based on the cooking course and the power information are displayed in operation S140/S270. As illustrated in FIG. 10, the present time is 13:50 between 13:00 and 14:00, and the peak time period ranges from 14:00 to 16:00, and the rest is the normal time period. When the cooking starts without delay, the estimated end time (‘END TIME’ of FIG. 10) is 14:35. In the power saving operation mode that the cooking starts out of the peak time period, the estimated end time is 16:45. When the cooking starts without delay, the estimated electricity charge (‘ELECTRICITY CHARGE’ of FIG. 10) is 300 wons. When the cooking is delayed, the estimated electricity charge is 120 wons. The cooking may be performed by pressing one of the cooking start button 530 and the delay cooking button 540 in operation S150/S280. When the delay cooking is selected, the time is elapsed using a timer in operation S161/S290, and then, the cooking is performed in operation S162/S291. When the delay cooking is not selected, the cooking is performed without delay in operation S170/S240.

In the method of controlling the cooking appliance, the power information may include the type of an outer power source that supplies power to the cooking appliance and a greenhouse gas index according to the outer power source. In addition, in the method of controlling the cooking appliance, an estimated greenhouse gas emission amount of the outer power source may be calculated in operation S261, and at least one of the type of the outer power source, the greenhouse gas index, and the estimated greenhouse gas emission amount may be output (not shown).

In the control device of the electric product and the method of controlling the electric product according to the present disclosure, the power is applied to the electric product, and power information including the electricity charge information is received from the outer device through the inner communication unit to provide the information to a user through the output unit. Therefore, the user can select a reasonable method for saving the power. Also, the power saving operation mode is performed within the peak time period to reasonably use energy.

In addition, in the control device of the electric product and the method of controlling the electric product according to the present disclosure, the type of an outer power source and a greenhouse gas index depending on the outer power source may be received from the outer device, and the estimated electricity charge and the greenhouse gas emission amount are calculated based on the type of the outer power source and the greenhouse gas index. Thus, the user can save the power. That is, in the control device of the electric product and the method of controlling the electric product according to the present disclosure, a user may confirm the reality of power usage of an electric product and electricity usage in real time, and be guided to voluntary energy saving. Thus, the peak power may be reduced at the national level to contribute to a build of the next generation power grid such as the smart grid.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

### INDUSTRIAL APPLICABILITY

In the control device and the method for controlling the electric product according to the embodiment, power information is provided to a user when the electric product operates, so that the user can reasonably select a process and perform a power saving operation.

1. A control device for controlling an electric product, comprising:
a power source unit configured to supply power to the electric product;
an input unit configured to input an operation mode related with a power saving driving of the electric product or input a command related with a driving method of the electric product;
an output unit configured to output information corresponding to the command input through the input unit or information related with driving of the electric product;
a communication unit configured to communicate information related with energy supplied to the electric product; and
a control unit configured to control an operation of the electric product based on a command related with the operation mode or a course of the driving,
wherein the operation mode includes a normal operation mode and a power saving operation mode, and
estimated energy information corresponding to the normal operation mode and the power saving operation mode is displayed on the output unit, in conjunction with the driving of the electric product.

2. The control device according to claim 1, wherein the output unit displays estimated energy information in the normal operation mode and estimated energy information in the power saving operation mode, and the estimated energy information corresponding to the normal operation mode is compared with the estimated energy information corresponding to the power saving operation mode on the output unit.

3. The control device according to claim 2, wherein the estimated energy information corresponding to the normal operation mode and the estimated energy information corresponding to the power saving operation mode are simultaneously displayed on the output unit.

4. The control device according to claim 2, wherein the estimated energy information corresponding to the normal operation mode and the estimated energy information corresponding to the power saving operation mode are sequentially displayed on the output unit.

5. The control device according to claim 1, wherein the estimated energy information comprises at least one of an estimated electricity charge, a driving start time, and an estimated driving end time.

6. The control device according to claim 5, wherein a present time is automatically selected as the driving start time, or a time that is at least partially disposed out of a peak time period, based on the energy information, is automatically selected as the driving start time.

7. The control device according to claim 5, wherein the driving start time is the same in the normal operation mode and the power saving operation mode, and the estimated driving end time is different in the normal operation mode and the power saving operation mode.

8. The control device according to claim 6, wherein the estimated driving end time in the power saving operation mode follows the estimated driving end time in the normal operation mode.

9. The control device according to claim 1, wherein when the electric product is a washing machine, a drying machine, a refrigerator, a cooking appliance, a water purifier, an air conditioner, a cleaner, or a massage device, the driving method of the electric product is determined according to a characteristic of the electric product.

10. The control device according to claim 9, wherein presetting the driving method is allowed, and the estimated energy information in the normal operation mode or the power saving operation mode according to the driving method is displayed to allow comparison of the estimated energy information.

11. The control device according to claim 1, wherein one of the normal operation mode and power saving operation mode is selected.

12. The control device according to claim 11, wherein when the power saving operation mode is selected, estimated energy information related with the power saving operation mode is displayed, and the electric product is operated according to the power saving operation mode.

13. The control device according to claim 11, wherein when the normal operation mode is selected, estimated energy information related with the normal operation mode and the power saving operation mode is displayed, and selecting one of the normal operation mode and the power saving operation mode is allowed.

14. The control device according to claim 13, wherein the electric product is operated in a selected operation mode.

15. A control device for controlling an electric product, comprising:
a communication unit configured to receive energy information supplied to the electric product;
an input unit configured to input an operation mode related with power saving driving of the electric product or input a command related with a driving method of the electric product;
an output unit configured to output information corresponding to the command input through the input unit or output information related with driving of the electric product; and
a control unit configured to control an operation of the electric product, based on a command related with the operation mode or a course of the driving,
wherein estimated energy information related with the operation of the electric product is displayed on the output unit, based on the operation mode, and
the estimated energy information includes time information.

16. The control device according to claim 15, wherein the time information comprises a driving start time or an estimated driving end time of the electric product.

17. The control device according to claim 16, wherein a present time is selected as the driving start time, or a time that is at least partially disposed out of a peak time period, based on the energy information, is selected as the driving start time.

18. The control device according to claim 15, wherein the estimated energy information comprises estimated charge information that is calculated according to the driving of the electric product.

19. The control device according to claim 15, wherein the estimated energy information comprises estimated power consumption that is consumed according to the driving of the electric product.

20. The control device according to claim 15, wherein the estimated energy information comprises an emission amount of greenhouse gas that is generated according to the driving of the electric product.

21. The control device according to claim 15, wherein the output unit displays a present time.

22. The control device according to claim 15, wherein the output unit displays a type of an outer power source.

23. The control device according to claim 22, wherein the outer power source comprises; a fossil fuel including oil or gas; an alternative energy source including solar light, solar heat, wind power, tidal power, water power, and geothermal power; nuclear power; or a fuel cell.

24. The control device according to claim 15, wherein the communication unit performs at least one of a power line communication, wireless LAN, Internet, Zigbee, and a serial communication.

25. A method of controlling an electric product, the method comprising:
receiving energy information supplied to an electric product;
inputting information about a driving method of the electric product;
displaying estimated energy information according to one or more operation modes, based on the energy information;
setting one of the operation modes; and
driving the electric product in the set operation mode.

26. The method according to claim 25, wherein the operation modes comprise a normal operation mode or one or more power saving operation modes.

27. The method according to claim 26, wherein estimated energy information in the normal operation mode and estimated energy information in the power saving operation mode are displayed such that the estimated energy information corresponding to the normal operation mode is compared with the estimated energy information corresponding to the power saving operation mode.

28. The method according to claim 25, wherein the energy information comprises estimated time information or estimated charge information according to the driving of the electric product.

29. The method according to claim 28, wherein the estimated time information comprises driving start time information or driving end time information of the electric product.
